(19) United States
(12) Patent Application Publication
(10) Pub. No.: US 2014/0246338 A1
(43) Pub. Date: Sep. 4, 2014

(54) Jewelry Storage Album

(71) Applicants: Guy M. Robby, Saratoga, CA (US); Nancy D. Robby, Saratoga, CA (US)

(72) Inventors: Guy M. Robby, Saratoga, CA (US); Nancy D. Robby, Saratoga, CA (US)

(21) Appl. No.: 13/783,263

(22) Filed: Mar. 2, 2013

(51) Int. Cl. A47F 7/02; F16M 13/02

(52) U.S. Cl. CPC A47F 7/02; F16M 13/02
USPC 206/6.1; 248/220.31

(57) ABSTRACT

A jewelry storage album having one or more mesh frame pages, hingedly coupled to a rigid cover, for storing and organizing a plurality of jewelry items. The mesh material of each mesh frame page contains a plurality of apertures. The mesh material has a high aperture to material ratio such that the mesh material is see-through, facilitating the placement and attachment of jewelry items such as: pierced earrings of the post and clasp configuration, and the hook type. The compartment formed by the mesh material and mesh frame, the spacing between the mesh frame pages, and the option to offset locations of jewelry on adjacent pages, provides jewelry on adjacent pages protection from damage by contact. Hanger loops removably attached to the mesh frame page allow placement and attachment of jewelry items such as: clip-on earrings, finger rings, bracelets, necklaces, pins, and the like.

### CROSS-REFERENCE TO RELATED APPLICATIONS

This application claims the benefit of provisional patent application Ser. No. 61/611,582 filed Mar. 16, 2012 by the present inventors.

### FEDERALLY SPONSORED RESEARCH

None

### SEQUENCE LISTING OR PROGRAM

None

### BACKGROUND OF THE INVENTION

1. Field

This invention generally relates to jewelry storage devices, specifically to binder and book type devices for holding and organizing a plurality of pierced earrings and other types of jewelry.

2. Prior Art

Most women today have a large number of jewelry items such as earrings, rings, necklaces, and the like. Because of the generally small nature of such jewelry items, these are often stored in jewelry boxes or the like which are intended to rest on a flat surface, such as a dresser, table, or the like. Such jewelry boxes contain a few compartments for storing the different jewelry items. Because the compartments are relatively large, numerous items of jewelry are generally stored in each compartment. The disadvantages to jewelry boxes are that they occupy much space on the flat surface, the jewelry items tend to become entangled and mixed with each other, and subsequently it is difficult for the user to locate the desired jewelry, find matching jewelry, or compare combinations of jewelry.

Therefore, it has been found desirable to place pierced earrings and other jewelry upon planar members having apertures defined therein with the shaft holding the earring in place on the planar member, thus displaying the earrings in close proximity to each other. Such a planar storage device is seen in U.S. Pat. No. 4,720,012 to Dufour entitled Jewelry Holder, where a plurality of mesh pages are included in a three-ring binder surrounded and separated by a cushioning page. The drawbacks to this design are: the necessity for a separate cushioning page, adding to the manufacturing cost, and the requirement for the use of a relatively stiff mesh material to be able to support a plurality of jewelry items hanging on it without bending. The three ring binder limits the number of mesh/cushion page combinations that can smoothly function in the binder.

Another planar storage device seen in U.S. Pat. No. 4,848,585 to Snyder entitled Jewelry Storage Case eliminates the need for cushioning between the trays by providing a rigid frame around the mesh material creating a tray with a cavity that holds the attached jewelry from being in too close a proximity to the jewelry attached to an adjacent tray when in a closed position. The drawbacks to this design being that the hinge configuration only allows for a maximum of three trays, the center tray is immovable and only the two outside trays can pivot to view the jewelry contained therein. This device is more of a jewelry case than a jewelry storage book or jewelry storage album.

Another planar storage device seen in U.S. Pat. No. 4,420,084 to Whelan entitled Jewelry Holding Device describes a book-like device for holding pierced earrings on a planar rigid sheet enclosed within a supporting frame, allowing the sheet to stand upright when hinged to another like sheet. This device, however, does not provide for a flexible planar sheet, such as a transparent or translucent mesh type fabric, supported within a book-like structure.

### SUMMARY

Accordingly, it is an object of this embodiment to provide a jewelry storage album for holding and organizing jewelry items, storing and organizing jewelry items in a tangle free manner, occupying a minimum amount of surface space, and easy and economical to manufacture and use. It is yet another object of this embodiment to provide a jewelry storage album in which the compartments formed by all of the mesh frame pages are simultaneously accessible.

In accordance with one embodiment of this invention, a jewelry storage album includes at least one single mesh frame page or a plurality of mesh frame pages for removably securing a plurality of jewelry items to the mesh frame page means; first and second covers hingedly connected to a spine for covering outermost ones of said mesh frame pages and supporting said jewelry storage book in a vertical or inclined orientation; and hinge means for hingedly securing the mesh frame pages and the first and second cover means together such that each mesh frame page and the first and second cover means can pivot about the hinge means with respect to each other. It is envisioned that embodiments of this device can be in a plurality of sizes, both large and small, and depending upon the number of mesh frame pages desired, to accommodate the desired number of jewelry items. The above and other objects, features and advantages of the present invention will become readily apparent from the following detailed description which is to be read in connection with the accompanying drawings.

### DRAWINGS—FIGURES

FIG. 1 is a perspective view of one embodiment of the device of this invention in an open position for receipt of pierced earrings and other jewelry items.

FIG. 1A is a perspective view of one embodiment of the device of this invention in a closed position.

FIG. 2 is a perspective view of a section of one embodiment of this invention showing the top hinge means and the top sections of the cover members and five mesh frame pages.

FIG. 3 is an exploded perspective view of a section of one embodiment of this invention showing the top hinge means, five hinge pins and the spine section of the cover.

FIG. 4 is a perspective view of one mesh frame page and an array of hanger loops hooked onto the mesh for a plurality of jewelry items, other than pierced earrings, such as, but not limited to, clip-on earrings, finger rings, necklaces, bracelets, and pins.

FIG. 5 is a perspective view of one hanger loop.

FIG. 6 is a perspective view of a section of a mesh frame page showing an array of pierced earrings with posts placed through the mesh apertures and secured with clasps.

FIG. 7 is a perspective view of an alternative embodiment of this invention in an open position for receipt of pierced earrings and other jewelry items.

FIG. 8 is a perspective view of a section of an alternative embodiment of this invention showing the top hinge means and the top sections of the covers and five mesh frame pages.

DRAWINGS-REFERENCE NUMERALS

```
  10 Front Cover
  20 Spine
  30 Back Cover
  40 Hinge Plate
  45 Hinge Plate Alternative Embodiment
  50 Mesh Frame
  60 Mesh Material
  70 Bumper Spacer
  80 Hinge Pin
  90 Hinge Pin Hole
  95 Hinge Pin Hole Alternative Embodiment
100 Hanger Loop
110 Pierced Earring
```

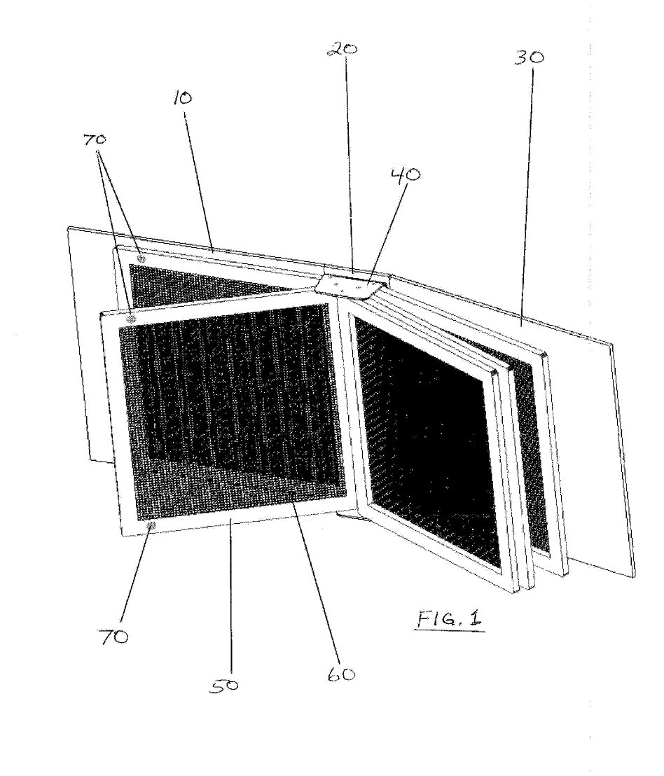

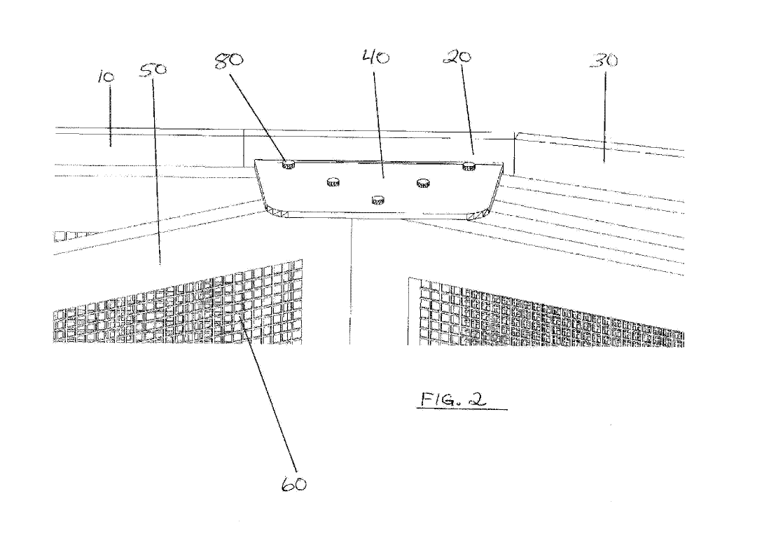

### DETAILED DESCRIPTION—FIRST EMBODIMENT—FIGS. 1, 2, and 3

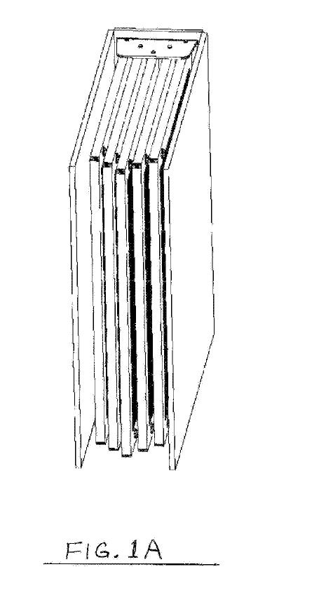

One embodiment of the jewelry storage album is shown in FIG. 1 (perspective view) and FIG. 2 (perspective view of the top section of the device). In the preferred embodiment, planar front cover 10 and planar back cover 30 are hingedly coupled to planar spine 20 such that front cover 10 and back cover 30 can rotate up to 180 degrees in relation to spine 20. Front cover 10, spine 20, and back cover 30, are manufactured from a rigid planar material such that the jewelry storage album will be self supporting, without bending, when bottom edges of front cover 10, spine 20, and back cover 30, are set on a planar surface, such as a table top, with the album in an open (shown in FIG. 1) or closed position (shown in FIG. 1A).

One leg of hinge plate 40 is securely fastened, using an adhesive or a fastener, parallel and flush to the surface of spine 20, so that the top leg with hinge pin holes 90 of hinge plate 40 is perpendicular to spine 20, in proximity to and parallel to the top edge of spine 20. One leg of a second hinge plate 40 is securely fastened parallel and flush to the surface of spine 20, so that the bottom leg with hinge pin holes 90 of hinge plate 40 is perpendicular to spine 20 and in proximity to and parallel to the bottom edge of spine 20.

In this embodiment each of five mesh frames 50, each containing mesh material 60, are hingedly connected to upper and lower hinge plates 40, with hinge pins 80, through hinge pin holes 90. It is envisioned that other embodiments of this device may contain one or more mesh frame pages 50. The placement and dimensions between hinge pin holes 90 in hinge plate 40 are located such that mesh frames 50 can rotate about their respective hinge pins 80, through a rotation angle of at least 90 degrees without restriction caused by contact with an adjacent mesh frame 50 or cover members 10, 20, or 30.

Each mesh frame page of the jewelry storage album is created from one four sided mesh frame 50 and mesh material 60. Mesh frame 50 is made of a rigid material having a solid or hollow cross section. Mesh material 60 is a planar sheet having a plurality of apertures therein. In a preferred embodiment of this device, a window screen is used as a mesh frame page. Apertures in mesh material 60 have dimensions large enough to accept the insertion of posts and hooks of standard jewelry, such as pierced earrings, through the aperture, and small enough to keep the posts and hooks from sliding out of an aperture when the posts or hooks have a holding clasp attached, similar to insertion through a pierced ear lobe. Alternatively, for pierced earrings having elongated curved hooks and no holding clasp, the elongated hook merely extends through an aperture. Mesh material 60 is securely fastened to mesh frame 50 so that mesh material 60 is held taut in a planar surface. It is envisioned that the mesh material 60 is held in position parallel and flush with one planar surface of the mesh frame 50, thereby creating a compartment or recess within the mesh frame 50 for the body of the jewelry fastened thereto, or the post or hook of jewelry fastened to the adjacent mesh frame page. In a preferred embodiment, mesh material 60 has a large ratio of aperture area to material area such that a user of the jewelry storage album can easily see through the mesh material 60. This makes it easy to place the holding clasp onto the earring post while holding the front body and looking through the mesh material 60. This also makes it easy to choose an appropriate location on the page in relation to jewelry attached to an adjacent page.

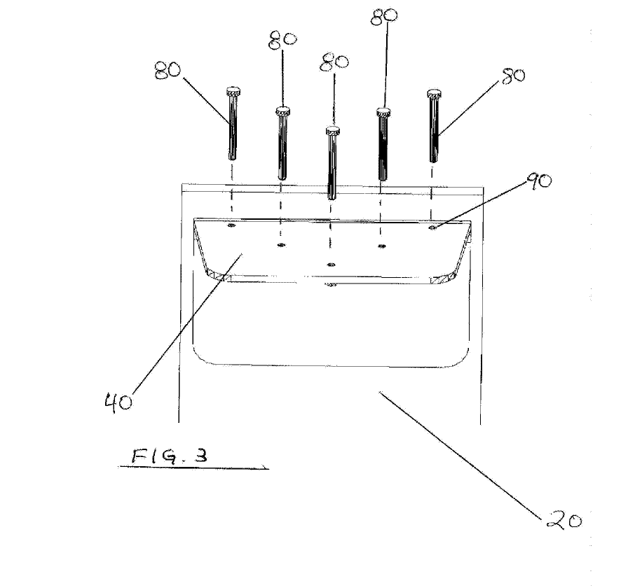

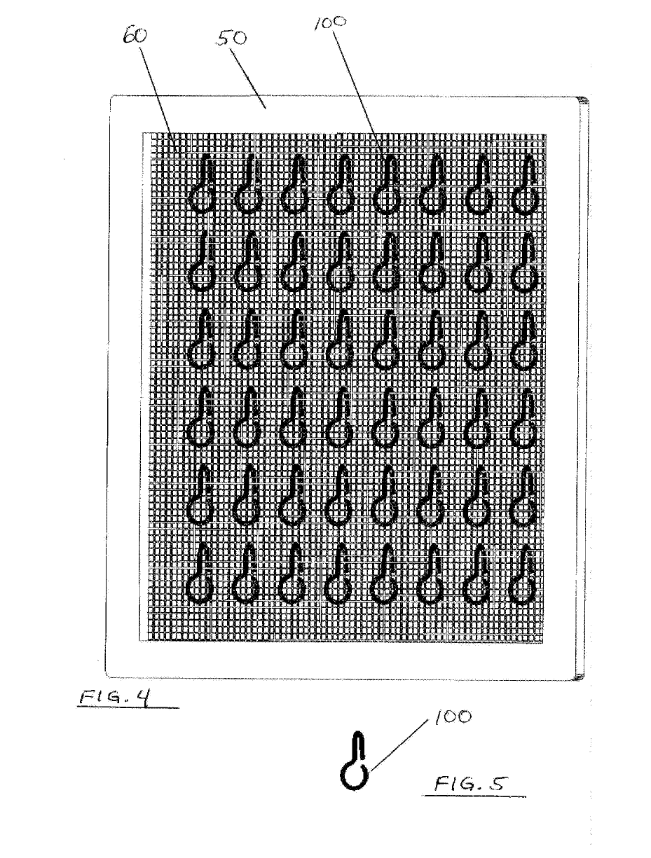

For other types of jewelry such as clip-on earrings, finger rings, bracelets, necklaces and the like, a hook and loop device, hanger loop 100, shown in FIG. 4 and FIG. 5, is provided. This hanger loop 100 has a hook on one end that is inserted into an aperture of mesh material 60, similar to the hook of a pierced earring, and an open ended loop on the other end to accept clip-on earrings, finger rings, bracelets, necklaces, pins and the like, placed onto the loop through the open end.

Each mesh frame page has one bumper spacer 70 fastened to or molded into one surface of the frame 50 at the top of the page and a second bumper spacer 70 fastened to or molded into the same surface of frame 50 at the bottom of the page as shown in FIG. 1. With the album in the closed position, each mesh frame page will be pressed against the adjacent mesh frame page. Bumper spacers 70, made from an elastomeric material or molded into the frame, will maintain extra space between the mesh frame pages when the album is in the closed position and allow more space for the bodies and posts and hooks of the attached jewelry within the compartments formed by the mesh frames 50 and mesh material 60.

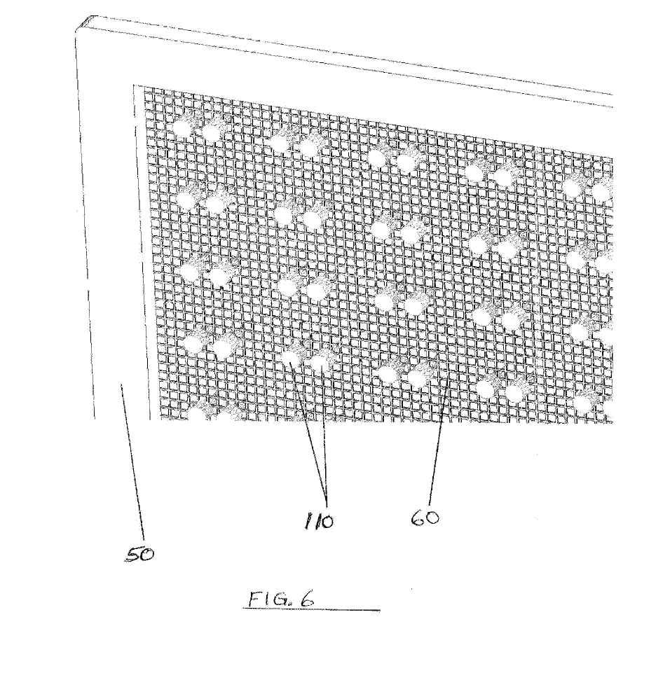

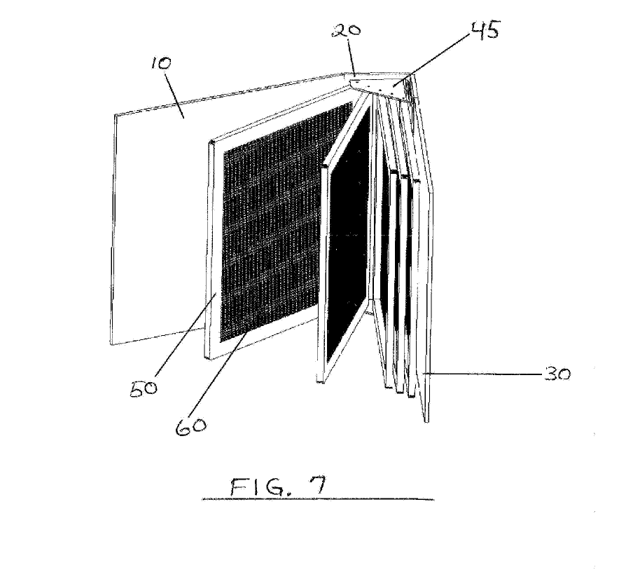

### Operation—First Embodiment—FIGS. 1-7

With the jewelry storage album in an open position, covers 10 and 30 positioned at an angle greater than 90 degrees in relation to the spine 20, (see FIG. 1), each mesh frame page 50 is rotated around its respective two hinge pins 80 through an angle of at least 90 degrees so a user can observe the next mesh frame page 50 in view and the jewelry in place on it. A user may also place jewelry on each mesh frame page 50 by passing an earring post, earring hook, or the hook of a hanger loop 100 through an aperture in the mesh material 60 and, if provided, fasten a holding clasp onto the end of the earring post, earring hook, or hook of a hanger loop to keep the earring post, earring hook, or hook of a hanger loop from slipping out of the aperture. In the preferred embodiment the envisioned mesh material 60 could be window screen fabric. Window screen fabric contains more aperture area than material area, so jewelry can be placed in any location on the mesh frame page. This will allow placing of jewelry mounted on one mesh frame page so it will not interfere with jewelry mounted on an adjacent mesh frame page when the pages are in close proximity to each other such as when the jewelry storage album is in a closed position. The see-through characteristic of the mesh material from one page to the next will facilitate said placement of jewelry.

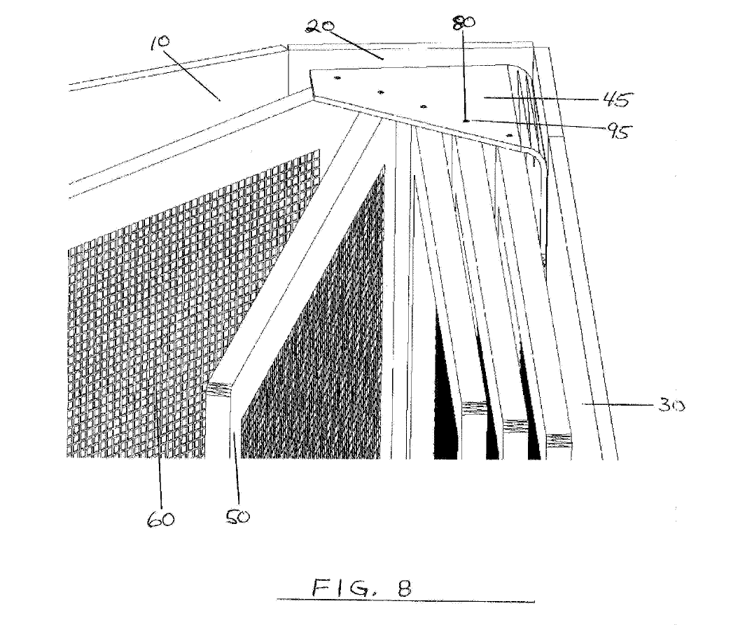

### Description—Alternative Embodiment—FIGS. 8-9

There are various possibilities for the hinge plate with regard to the shape, layout of the hinge pin holes, and the mounting position on the album cover. An alternative embodiment of the jewelry storage album is shown in FIG. 8 (perspective view) and FIG. 9 (perspective view of the top section of the device). In the alternative embodiment, planar front cover 10, planar back cover 30, and planar spine 20 are as described in the first embodiment.

One leg of hinge plate 45 is securely fastened parallel and flush to the surface of the back cover 30, so that the top leg with hinge pin holes 95 of hinge plate 45 is perpendicular to back cover 30, in proximity to and parallel to the top edge of back cover 30 and in proximity to spine 20. One leg of a second hinge plate 45 is securely fastened parallel and flush to the surface of the back cover 30, so that the top leg with hinge pin holes 95 of hinge plate 45 is perpendicular to back cover 30, in proximity to and parallel to the bottom edge of back cover 30 and in proximity to spine 20.

In this alternative embodiment each of five mesh frames 50, each containing mesh material 60, is hingedly connected to upper and lower hinge plates 45, with hinge pins 80, through hinge pin holes 95. It is envisioned that other embodiments of this device may contain one or more mesh frame pages 50. The placement and dimensions between hinge pin holes 95 in upper and lower hinge plates 45 are located such that mesh frames 50 can rotate about their respective hinge pins 80, through a rotation angle of at least 90 degrees without restriction caused by contact with an adjacent mesh frame 50 or cover members 10, 20, or 30.

Each mesh frame page has one bumper spacer 70 fastened to or molded into one surface of the frame 50 at the top of the page and a second bumper spacer 70 fastened to or molded into the same surface of frame 50 at the bottom of the page as shown in FIG. 8. With the album in the closed position, each mesh frame page will be pressed against the adjacent mesh frame page. Bumper spacers 70, made from an elastomeric material or molded into the frame, will maintain extra space between the mesh frame pages when the album is in the closed position and allow more space for the bodies and posts and hooks of the attached jewelry within the compartments formed by the mesh frames 50 and mesh material 60.

### Operation—Alternative Embodiment—FIGS. 8-9

### See Operation—First Embodiment

### Conclusion, Ramifications, and Scope

Accordingly the reader will see that, according to one embodiment of the invention, I have provided a jewelry storage album for holding and organizing jewelry items, storing and organizing jewelry items in a tangle free manner, occupying a minimum amount of surface space, and easy and economical to manufacture and use. This embodiment provides a jewelry storage book in which the compartments formed by all of the mesh frame pages are simultaneously accessible. Furthermore, this embodiment has the additional advantages in that:
The pages may be fabricated with a flexible, see-through, mesh material having a high ratio of aperture area to material area, making attachment of jewelry easier by allowing the user to see the front end and clasp end of the jewelry at the same time while attaching the jewelry to the mesh material.
The pages fabricated with mesh material having a high ratio of aperture area to material area and a high density of apertures equally distributed across the mesh frame page, allows a user to attach a plurality of jewelry items at any location, restricted only by the size of the jewelry item.
The mesh frame pages of this embodiment allow a user to easily view all of the jewelry stored on that page at once, and, if applicable, in matched pairs, and by a simple turning of the page, view the next pages in like manner.
By use of the hanger loop, the mesh material can have one size aperture throughout. Slotted apertures or apertures of various sizes are not necessary to hold jewelry that does not have a post or hook, such as clip-on earrings, finger rings, bracelets, necklaces, pins and the like.

While the above description contains many specificities, these should not be construed as limitations on the scope of any embodiment, but as exemplifications of the presently preferred embodiments thereof. Many other ramifications and variations are possible within the teachings of the various embodiments. For example, the hinge plates can have other shapes, the hinge pin holes can be in alternate locations on the hinge plate, the hinge plates can be attached in alternate positions and locations on the cover, the page frames can be semi-rigid or rigid, the page frames and the mesh material can be manufactured of the same material at the same time, as with a molding process, instead of several parts fastened together.

Thus the scope of the invention should be determined by the appended claims and their legal equivalents, and not by the examples given.

I claim:

1. A portable book-like device for holding, organizing, and storing jewelry comprising:
a. at least one mesh frame page having mesh material containing a plurality of apertures of a size large enough to allow the post or hook of an earring to pass through the aperture, but small enough to restrict the post or hook from slipping out of the aperture when a post or hook clasp is fastened to the post or hook;
b. first and second cover means hingedly connected to a spine means for covering said at least one mesh frame page and for supporting said jewelry storage album in a vertical orientation;
c. said at least one mesh frame page having said mesh material supported in a planar direction by a rigid or semi-rigid four sided frame wherein said mesh material is attached parallel to and in the same plane as either the front or back surface of said four sided frame, and said mesh material attached to said four sided frame forming a compartment within said four sided frame allowing enough space between said mesh material and the said cover means to protect jewelry attached to said mesh material when said jewelry storage album is in a closed position;
d. hinge means for hingedly securing said at least one mesh frame page and said cover means together.

2. The device of claim 1 containing a plurality of mesh frame pages hingedly connected to said cover means;
a. hinge means for hingedly securing said plurality of mesh frame pages and said cover means together such that each mesh frame page can rotate at least 90 degrees without contacting an adjacent said mesh frame page or said cover.
b. each said four sided frame having a depth dimension large enough to allow sufficient space between said mesh frame page mesh material and an adjacent said mesh frame page mesh material to prevent jewelry attached to said mesh material on said mesh frame page from damaging jewelry attached to said mesh material on said adjacent mesh frame page when said jewelry storage album is in an open or closed position;
c. each said mesh frame page having said mesh material with a sufficient quantity of said apertures such that jewelry attached to said mesh material in any location on one mesh frame page may be offset from the location of jewelry on a said adjacent mesh frame page such that these two pieces of jewelry shall not damage each other by contact;

3. The device of claim 1 having said at least one mesh frame page with said mesh material having a high density of apertures per square area and a high aperture to material ratio such that a user of said jewelry storage album can see through said mesh material facilitating placement and attachment of jewelry onto said mesh material.

4. The device of claim 2 having said plurality of mesh frame pages with said mesh material having a high density of apertures per square area and a high aperture to material ratio such that a user of said jewelry storage album can see through said mesh material facilitating placement and attachment of jewelry onto said mesh material.

5. A loop with an attached hook of rigid, wire-like material with a maximum cross-sectional dimension such that said hook will pass through said apertures of said mesh material of said mesh frame page and of such tensile strength that said loop-hook combination will support the weight of jewelry hung from said loop as in clip-on earrings, finger rings, bracelets, necklaces, pins, and the like, without deforming.
